(19) United States
(12) Patent Application Publication
(10) Pub. No.: US 2020/0100126 A1
(43) Pub. Date: Mar. 26, 2020

(54) Physical Downlink Control Channel Monitoring Configuration In Mobile Communications

(71) Applicant: MediaTek Singapore Pte. Ltd., Singapore (SG)

(72) Inventors: Abdellatif Salah, Cambridge (GB); Mohammed S Aleabe Al-Imari, Cambridge (GB)

(21) Appl. No.: 16/584,903

(22) Filed: Sep. 26, 2019

Related U.S. Application Data
(60) Provisional application No. 62/736,505, filed on Sep. 26, 2018.

(51) Int. Cl. H04W 24/08; H04W 28/02; H04W 72/04; H04L 5/00

(52) U.S. Cl. CPC H04W 24/08; H04L 5/0055; H04W 72/042; H04W 28/0278

(57) ABSTRACT

Various solutions for physical downlink control channel (PDCCH) monitoring configuration with respect to user equipment and network apparatus in mobile communications are described. An apparatus may receive a primary configuration and a secondary configuration. The apparatus may monitor a PDCCH according to the primary configuration. The apparatus may determine whether a condition is satisfied. The apparatus may monitor the PDCCH according to the secondary configuration in an event that the condition is satisfied. The primary configuration may comprise a first PDCCH periodicity. The secondary configuration may comprise a second PDCCH periodicity which is smaller than the first PDCCH periodicity.

### CROSS REFERENCE TO RELATED PATENT APPLICATION(S)

The present disclosure is part of a non-provisional application claiming the priority benefit of U.S. Patent Application No. 62/736,505, filed on 26 Sep. 2018, the content of which is incorporated by reference in its entirety.

### TECHNICAL FIELD

The present disclosure is generally related to mobile communications and, more particularly, to physical downlink control channel (PDCCH) monitoring configuration with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low latency communications (URLLC) is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶ BLER.

In enhanced URLLC (eURLLC), more stringent requirements in terms of latency (e.g., 0.5-1 ms) and reliability (e.g., 1e-6) are even proposed. To meet the stringent latency requirements, some proposals are raised to define further aggressive UE processing time capabilities. However, the further shortened processing time will put a lot of constraint on the UE design and increase its complexity, cost and power consumption. Another alternative to improve the latency is to have multiple PDCCH monitoring occasions within the slot to get the full benefits of the short type-B scheduling. But this will increase the blind decodes and the complexity at the UE side.

Accordingly, how to meet the stringent latency requirements without increasing UE design complexity and implementation cost becomes an important issue for the newly developed wireless communication network. Therefore, it is needed to provide better schemes to properly monitor the PDCCH for uplink and/or downlink traffic.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to PDCCH monitoring configuration with respect to user equipment and network apparatus in mobile communications.

In one aspect, a method may involve an apparatus receiving a primary configuration and a secondary configuration. The method may also involve the apparatus monitoring a PDCCH according to the primary configuration. The method may further involve the apparatus determining whether a condition is satisfied. The method may further involve the apparatus monitoring the PDCCH according to the secondary configuration in an event that the condition is satisfied. The primary configuration may comprise a first PDCCH periodicity. The secondary configuration may comprise a second PDCCH periodicity which is smaller than the first PDCCH periodicity.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a primary configuration and a secondary configuration from the network node. The processor may also perform operations comprising monitoring, via the transceiver, a PDCCH according to the primary configuration. The processor may further perform operations comprising determining whether a condition is satisfied. The processor may further perform operations comprising monitoring, via the transceiver, the PDCCH according to the secondary configuration in an event that the condition is satisfied. The primary configuration may comprise a first PDCCH periodicity. The secondary configuration may comprise a second PDCCH periodicity which is smaller than the first PDCCH periodicity.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (loT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10 is a diagram depicting an example scenario under schemes in accordance with implementations of the present disclosure.

FIG. 11 is a block diagram of an example communication apparatus and an example network apparatus in accordance with an implementation of the present disclosure.

FIG. 12 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to PDCCH monitoring configuration with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In NR, URLLC is supported for emerging applications that demands high requirements on end-to-end latency and reliability. A general URLLC reliability requirement is that a packet of size 32 bytes shall be transmitted within 1 millisecond end-to-end latency with a success probability of 10⁻⁵. URLLC traffic is typically sporadic and short whereas low-latency and high-reliability requirements are stringent. For example, the control reliability of URLLC has to be stricter than the data reliability which is up to 10⁻⁶BLER.

In enhanced URLLC (eURLLC), more stringent requirements in terms of latency (e.g., 0.5-1 ms) and reliability (e.g., 1e-6) are even proposed. To meet the stringent latency requirements, some proposals are raised to define further aggressive UE processing time capabilities. However, the further shortened processing time will put a lot of constraint on the UE design and increase its complexity, cost and power consumption. Another alternative to improve the latency is to have multiple PDCCH monitoring occasions within the slot to get the full benefits of the short type-B scheduling. But this will increase the blind decodes and the complexity at the UE side. A new approach that will be explored in the present disclosure is to study the latency for uplink (UL) and downlink (DL) and identify the bottleneck that is slowing down the transmission procedure, and some solutions will be proposed to reduce the latency while maintaining reasonable UE complexity.

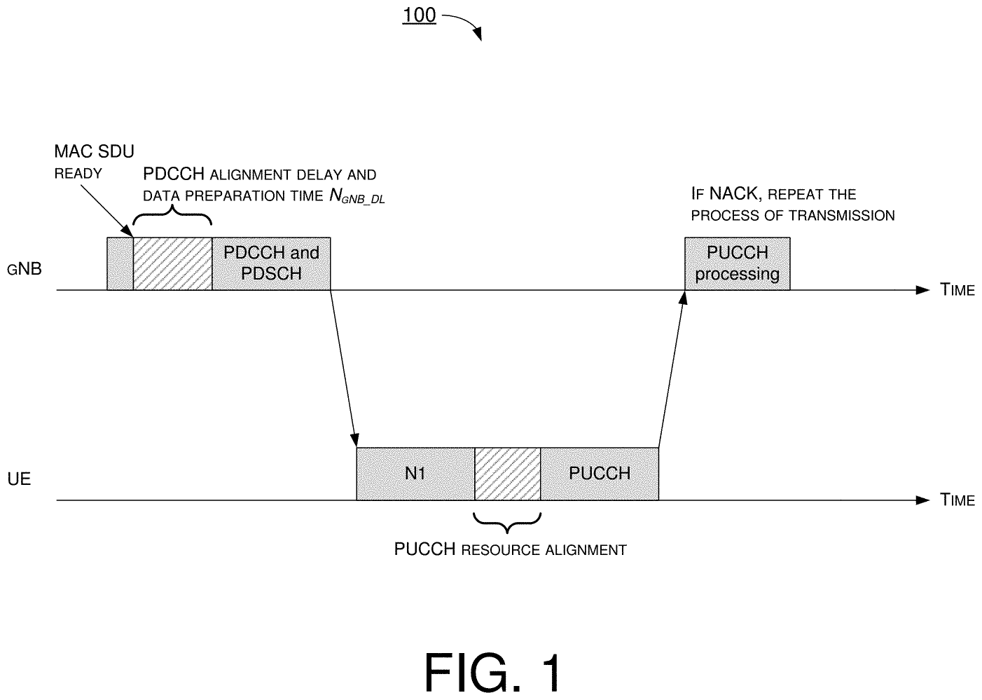

FIG. 1 illustrates an example scenario 100 under schemes in accordance with implementations of the present disclosure. Scenario 100 involves a UE and a network node (e.g., gNB), which may be a part of a wireless communication network (e.g., an LTE network, an LTE-Advanced network, an LTE-Advanced Pro network, a 5G network, an NR network, an loT network or an NB-IoT network). Scenario 100 illustrates the DL latency associated with different channels with a single hybrid automatic repeat request (HARQ) transmission. When the medium access control (MAC) service data unit (SDU) is ready at the gNB, the gNB may be configured to prepare the transmission of the PDCCH and physical downlink shared channel (PDSCH). Then, the gNB may transmit the PDCCH and PDSCH to the UE. After receiving the PDCCH and PDSCH, the UE may need a period of processing time (e.g., N1) to process the PDCCH and PDSCH. The UE may be configured to prepare the UL data (e.g., ACK/NACK) and wait for the physical uplink control channel (PUCCH) transmission. Then, the UE may transmit the PUCCH to the gNB. After receiving the PUCCH, the gNB may need to process the PUCCH. In an event that the PUCCH comprises a NACK, the gNB may be configured to repeat the process of transmission.

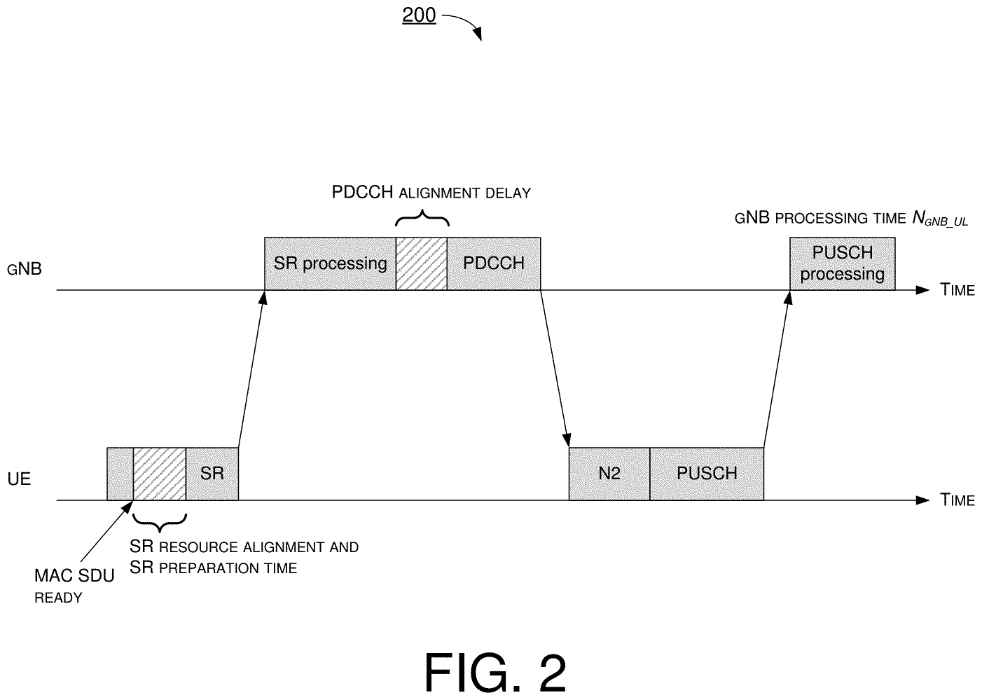

FIG. 2 illustrates an example scenario 200 under schemes in accordance with implementations of the present disclosure. Scenario 200 involves a UE and a network node (e.g., gNB), which may be a part of a wireless communication network (e.g., an LTE network, an LTE-Advanced network, an LTE-Advanced Pro network, a 5G network, an NR network, an loT network or an NB-IoT network). Scenario 200 illustrates the UL latency associated with different channels with a single HARQ transmission. When the MAC SDU is ready at the UE, the UE may be configured to prepare the transmission of the service request (SR) message. The SR message is used to request uplink resources. Then, the UE may transmit the SR message to the gNB. After receiving the SR message, the gNB may need a period of processing time to process the SR message. In response to the SR message, the gNB may be configured to prepare the PDCCH and wait for the PDCCH transmission. Then, the gNB may transmit the PDCCH to the UE. After receiving the PDCCH, the UE may need a period of processing time (e.g., N2) to process the PDCCH. After receiving the PDCCH, the UE may be further configured to transmit the physical uplink shared channel (PUSCH) to the gNB. After receiving the PUSCH, the gNB may be configured process the PUSCH.

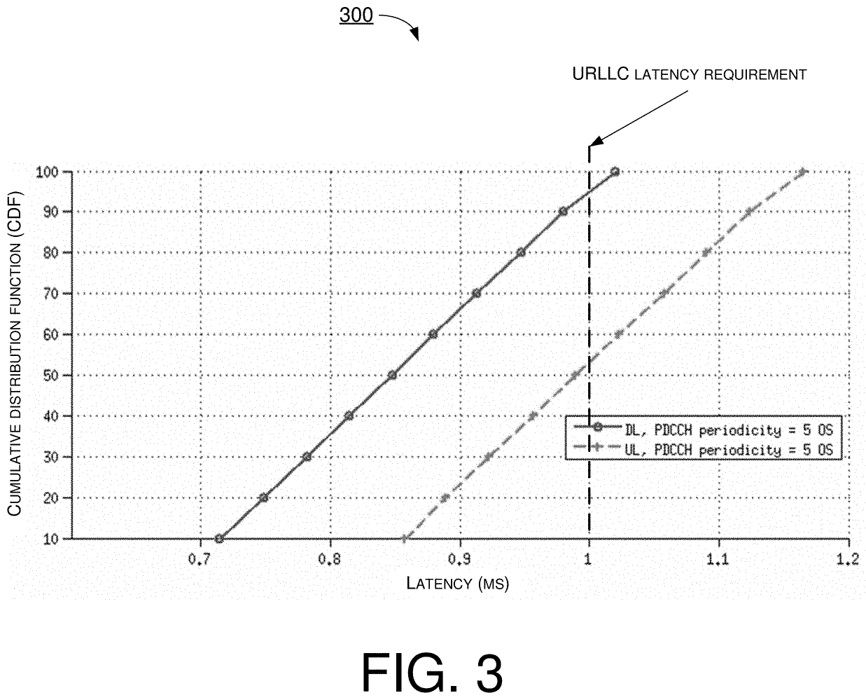

For the single shot trans5 orthogonal frequency-division multiplexing (OFDM) symbols (OS), SR periodicity=2 OS, SR duration=1 OS, and SR processing=SR duration. The UE processing time is N2 for DL and N1 for UL. The NR control resource set (COREST) duration=1 OS, PUSCH duration=2 OS, PDSCH duration=2 OS, and sub-carrier spacing (SCS)=15 kHz. FIG. 3 illustrates an example scenario 300 under schemes in accordance with implementations of the present disclosure. Scenario 300 illustrates the estimated latency for the DL and UL transmissions illustrated in FIG. 1 and FIG. 2. As shown in FIG. 3, the UL latency is higher than the DL latency. Assuming that the URLLC latency requirement is 1 ms, the UL transmission cannot meet the latency requirement of URLLC. In addition, for many URLLC applications such as augmented reality (AR)/virtual reality (VR), latency requirements in UL are much more stringent than requirements in DL and requires a lot of PDCCH monitoring effort to meet the latency requirements.

In view of the above, the present disclosure proposes a number of schemes pertaining to PDCCH monitoring configuration with respect to the UE and the network apparatus. According to the schemes of the present disclosure, the monitoring with different PDCCH periodicities may be configured. Since DL and UL transmissions have different latency performances, separated PDCCH monitoring configurations for DL and UL may be applied. More frequent PDCCH monitoring (e.g., shorter PDCCH periodicity) may be applied on monitoring UL traffic to reduce transmission latency. With separated PDCCH monitoring configurations, both latency requirements of URLLC for DL and UL may be met. On the other hand, the number of PDCCH blind decoding at the UE side can be control in a reasonable amount to reduce power consumption. The UE implementation complexity and cost may also be maintained within a reasonable level.

Specifically, the UE may be configured to receive a primary configuration and a secondary configuration. The primary configuration may comprise a first PDCCH periodicity. The secondary configuration may comprise a second PDCCH periodicity which is smaller than the first PDCCH periodicity. The UE may be configured to monitor the PDCCH according to the primary configuration by default. Then, the UE may determine whether a condition is satisfied. In an event that the condition is satisfied, the UE may be configured to monitor the PDCCH according to the secondary configuration. The primary configuration may be used to monitor the DL traffic. The secondary configuration may be used to monitor the UL traffic.

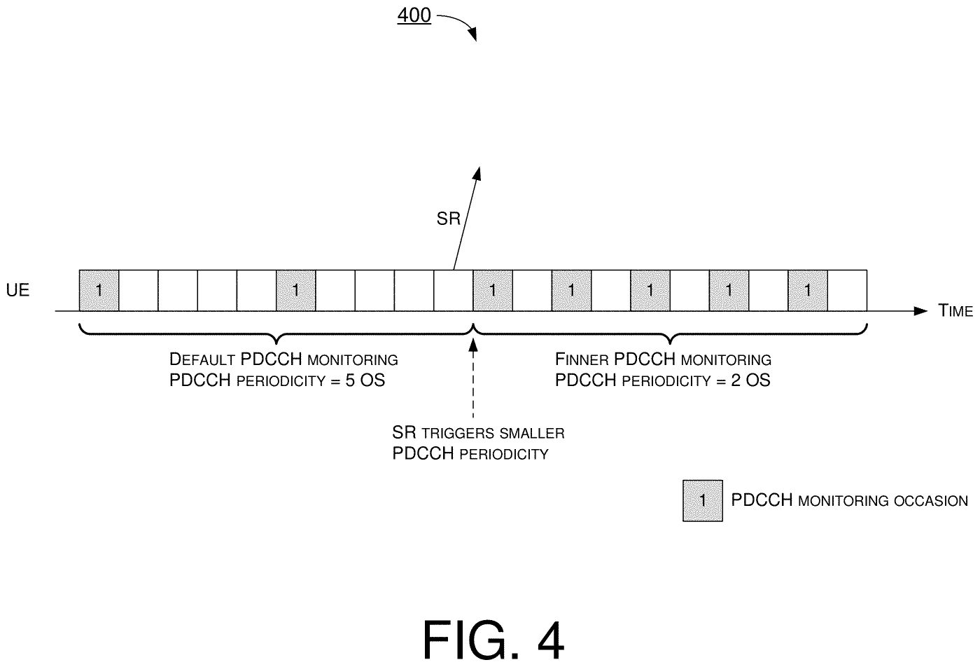

FIG. 4 illustrates an example scenario 400 under schemes in accordance with implementations of the present disclosure. Scenario 400 involves a UE and a network node, which may be a part of a wireless communication network (e.g., an LTE network, an LTE-Advanced network, an LTE-Advanced Pro network, a 5G network, an NR network, an loT network or an NB-IoT network). Scenario 400 illustrates the scenario of changing PDCCH monitoring periodicity triggered by a service request (SR) message. The UE may be configured with a first PDCCH monitoring configuration and a second PDCCH monitoring configuration. The first PDCCH monitoring configuration comprises PDCCH periodicity=5 OS. The second PDCCH monitoring configuration comprises 5 OS). Then, the UE may be configured to transmit an SR message to the network node. After transmitting the SR message, the UE may expect the following DL transmission from the network node on the PDCCH. Therefore, the transmission of the SR message may trigger the UE to perform finer PDCCH monitoring. Then, the UE may be configured to monitor the PDCCH according to the second PDCCH monitoring configuration (e.g., every 2 OS). Since using small PDCCH periodicities all the time will increase the UE complexity, blind decoding, and power consumption, having different PDCCH periodicities will allow to meet the latency requirements for UL and DL with less UE complexity and power consumption.

The UE may be configured with a secondary configuration that is applied at certain period of times based on specific triggers/conditions. The specific triggers/conditions may comprise transmitting at least one of an SR message, a negative acknowledgement (NACK), and a buffer status report (BSR). For example, the UE may be configured with a primary and a secondary PDCCH monitoring configurations in the same search space. The primary PDCCH monitoring configuration may comprise some parameters such as monitoring-offset-PDCCH-slot, monitoring-periodicity-PDCCH-slot, and monitoring-symbols-PDCCH-within-slot. The secondary PDCCH monitoring configuration may comprise some parameters such as monitoring-offset-PDCCH-slot-secondary, monitoring-periodicity-PDCCH-slot-secondary, and monitoring-symbols-PDCCH-within-slot-secondary. In another example, the UE may be configured with a search space that is monitored at certain period of times based on specific triggers/conditions. Accordingly, the secondary configuration may comprise at least one of a secondary PDCCH monitoring configuration and a search space to be monitored at a period of time.

The primary configuration and/or the secondary configuration may be configured by the network node via the radio resource control (RRC) configuration. The parameters used for the secondary configuration may be predetermined (e.g., specified in 3^{rd} Generation Partnership Project (3GPP) specifications) and/or pre-stored in the UE. The secondary configuration may be deterministic. For example, the secondary configuration may depend on the default configuration. In another example, the secondary configuration may depend on other parameters such as SCS, type of scheduling, etc. The use of the secondary configuration may be enabled and/or disabled by the RRC configuration. The use of the secondary configuration may also be triggered dynamically via the DCI. The settings for the secondary configuration may be signalled/changed dynamically. The secondary configuration may be used for a temporary duration, and then the UE will switch back to the default configuration. The primary configuration may be monitored by the UE during the period where the secondary configuration is monitored by the UE. Alternatively, the primary configuration may be not monitored by the UE during the period where the secondary configuration is monitored by the UE.

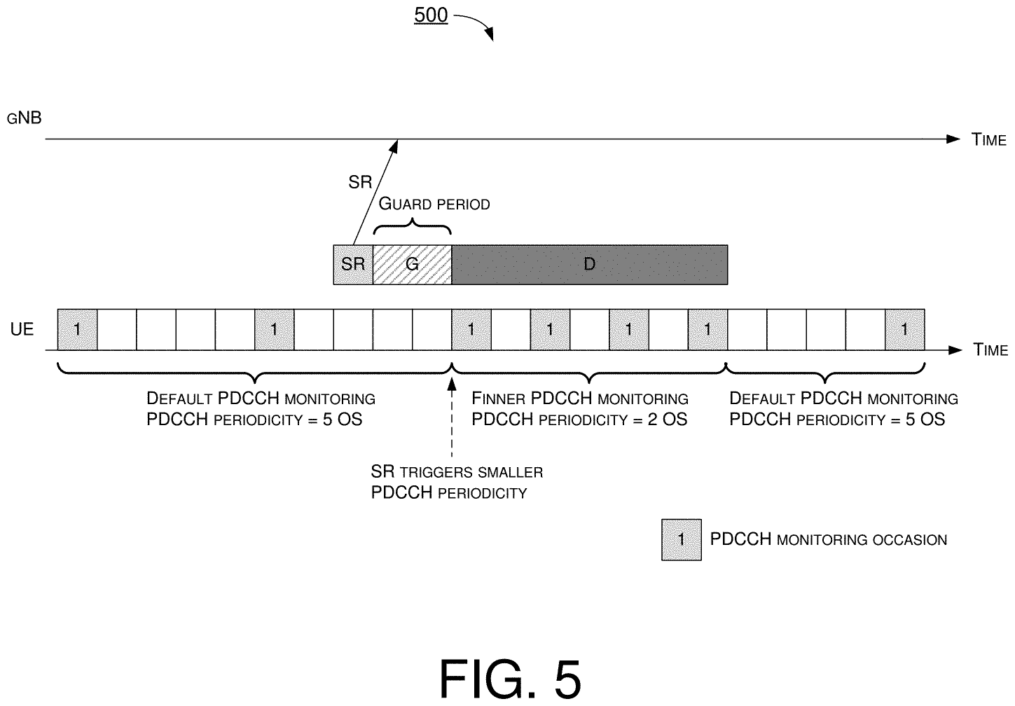

FIG. 5 illustrates an example scenario 500 under schemes in accordance with implementations of the present disclosure. Scenario 500 involves a UE and a network node, which may be a part of a wireless communication network (e.g., an LTE network, an LTE-Advanced network, an LTE-Advanced Pro network, a 5G network, an NR network, an loT network or an NB-IoT network). The UE may be configured to initiate the monitoring of the PDCCH according to the secondary configuration after a guard period from transmitting at least one of the SR message, the NACK, and the BSR. Specifically, a guard period (e.g., G) may be defined. The guard period may be used to account for the SR propagation time and the network node processing time of the SR message. During the guard period, the primary configuration may still be used. The length and/or position of the guard period may be determined according to practical implementations. For example, the start of the period G may be straight after the SR transmission. The value of G may be zero or may be different from zero. G may be equal to X symbols, where X is equal or greater than the propagation time and the SR processing time at the network node. The value of G may be predetermined or RRC configured. The length of G may depend on other parameters such as SCS, etc. A duration D may be defined when the secondary configuration with more monitoring occasions is used. The secondary configuration may be configured via the higher layer parameter (e.g., monitoringSymbolsWithinSlot). The duration D may be defined in terms of a time duration (e.g., 1 ms), number of slots, number of OS, or number of PDCCH monitoring occasions. For example, the duration D may be defined as only one or multiple monitoring occasions.

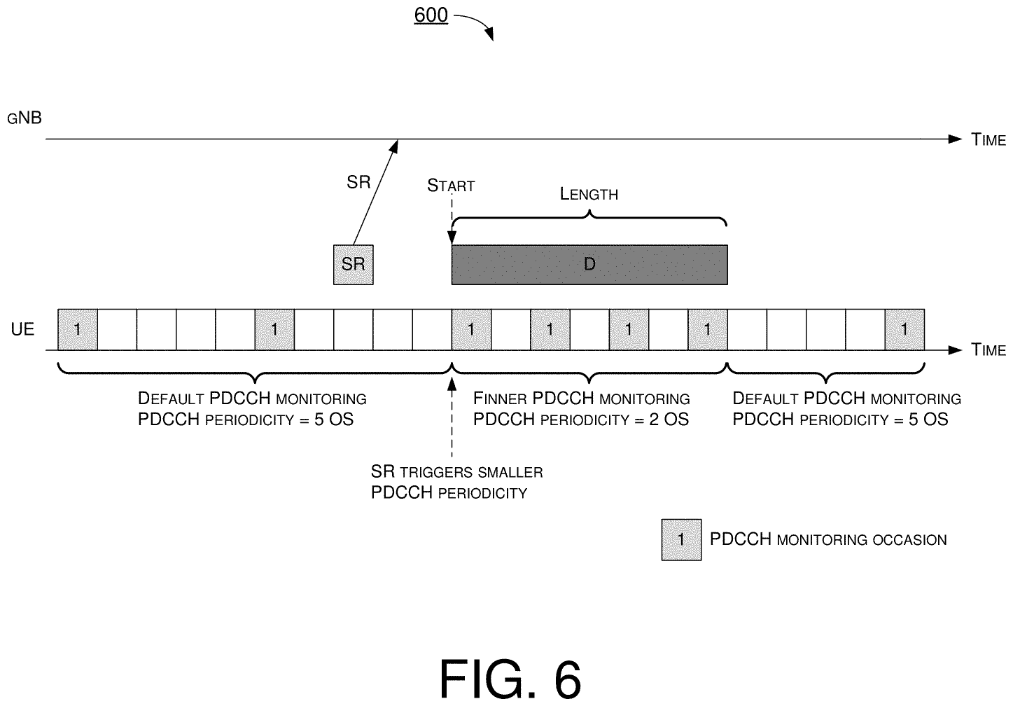

FIG. 6 illustrates an example scenario 600 under schemes in accordance with implementations of the present disclosure. Scenario 600 involves a UE and a network node, which may be a part of a wireless communication network (e.g., an LTE network, an LTE-Advanced network, an LTE-Advanced Pro network, a 5G network, an NR network, an loT network or an NB-IoT network). In scenario 600, the secondary configuration may be enabled during a temporary duration (e.g., D). The UE may be configured to monitor the PDCCH according to the secondary configuration in the temporary duration. The start and the length of the temporary duration may be known to both the UE and the network node. At least one of the start and the length of the temporary duration may comprise a predetermined value or a configured value received from the network node. For example, the start and the length of the temporary duration may be predetermined (e.g., specified 3GPP specifications) or RRC configured. The start may be defined with reference to the transmitted SR message or to the slot boundary. In an event that the start is defined by using the slot boundary as a starting reference, one or multiple possible starts may be defined within the slot.

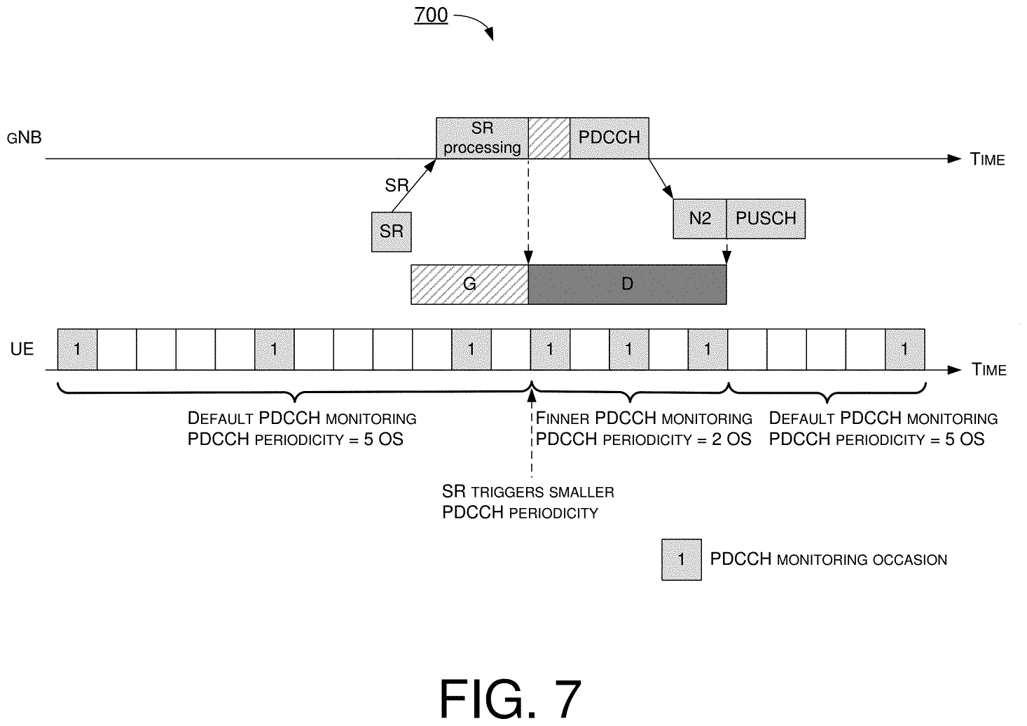

FIG. 7 illustrates an example scenario 700 under schemes in accordance with implementations of the present disclosure. Scenario 700 involves a UE and a network node, which may be a part of a wireless communication network (e.g., an LTE network, an LTE-Advanced network, an LTE-Advanced Pro network, a 5G network, an NR network, an loT network or an NB-IoT network). Scenario 700 illustrates possible implementations for the length of the temporary duration (e.g., D). The length of the temporary duration may be a fixed durat1 ms). The temporary duration may be finished after receiving or transmitting the relevant information/data. For example, the temporary duration may be finished after receiving the UL scheduling DCI via the PDCCH, or after N2 processing time after receiving the UL scheduling DCI via the PDCCH. In another example, the temporary duration may be finished after transmitting the UL data packet via the PUSCH. When the the temporary duration is finished, the UE may be configured to stop monitoring the PDCCH according to the secondary configuration and switch back to the default PDCCH monitoring configuration (e.g., the primary configuration).

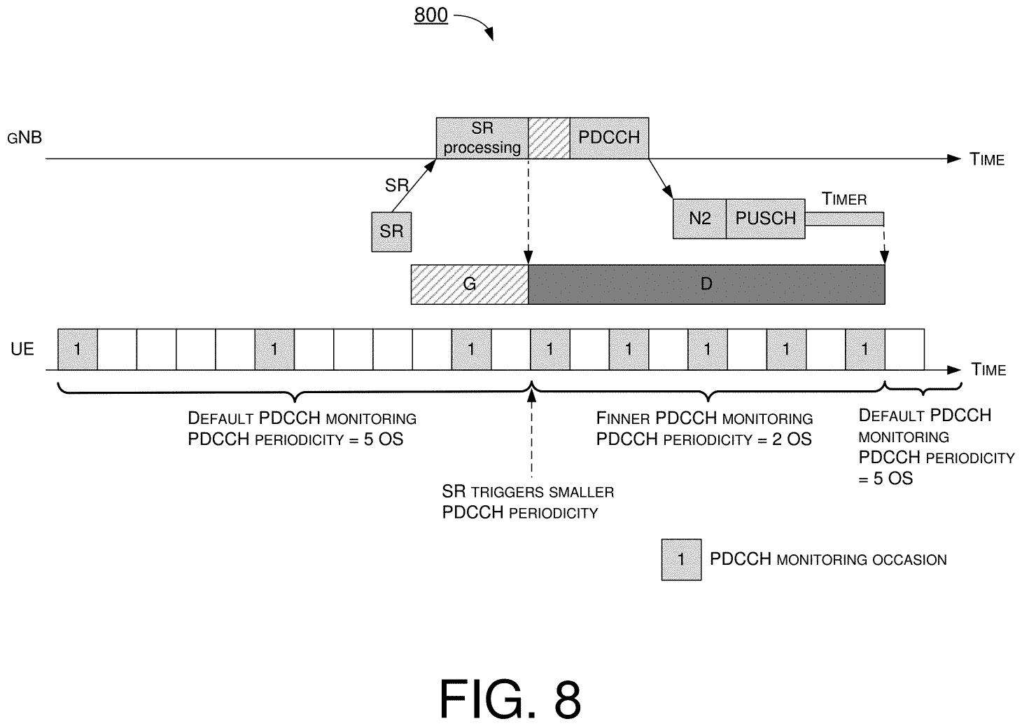

FIG. 8 illustrates an example scenario 800 under schemes in accordance with implementations of the present disclosure. Scenario 800 involves a UE and a network node, which may be a part of a wireless communication network (e.g., an LTE network, an LTE-Advanced network, an LTE-Advanced Pro network, a 5G network, an NR network, an loT network or an NB-IoT network). Scenario 800 illustrates other possible implementations for the length of the temporary duration (e.g., D). The temporary duration may be finished after a fixed duration from when the PUSCH is transmitted. For example, the additional duration may comprise allowable time for the network node to decode and send another UL DCI for retransmission in an event that the packet is not decoded (e.g., gNB processing time+1 PDCCH period). The temporary duration may also be extended to the next PUSCH in an event that there is data to be transmitted (e.g., the packet to be retransmitted). In another example, the UE may initiate a timer that is started after the PUSCH is transmitted. When the timer expires, the UE may be configured to stop monitoring the PDCCH according to the secondary configuration and switch back to the default PDCCH monitoring configuration (e.g., the primary configuration).

In some implementations, the temporary duration may take into account the buffer status report (BSR) information if available at the network node. The use of the secondary configuration may be extended when the UE has more data in its buffer. The network node may recognize that the secondary configuration was extended based on the BSR information. In an event that the BSR information is not available, the UE may, by its own initiative, extend the use of the secondary configuration in an event that it still has more data to be transmitted, and switch back to the primary configuration once all the UL data are sent out. The network node may recognize that by making the assumption that the UE may have more UL data to be sent out. Once the allocated resources are not used by the UE, the network node may recognize the UE has sent out all of its data and switched to the primary configuration. For all the implementations above, in order to reduce the monitoring effort, the UE may switch back temporarily to the primary configuration during the processing time (e.g., N2) and the PUSCH transmission time.

In some implementations, supporting the secondary configuration may be defined as a feature or as a UE capability. The UE may indicate whether it can support the secondary configuration in the capability report. The use of secondary configuration may also be limited to some configurations or parameters such as SCS, carrier frequency, type-B scheduling, etc.

In some implementations, supporting the secondary configuration may be restricted to some specific services (e.g., URLLC services or enhanced mobile broadband (eMBB) services), or may be applicable to all services. As SR is linked to one or more logical channels, the UE is expected to switch to the secondary configuration only when it transmits some specific SRs. The specific SRs may be linked to specific logical channel(s) (e.g., carrying URLLC data). Different secondary configuration may be signalled for each different service, or the same secondary configuration may be signalled for all services. Different secondary configuration may also be signalled for each set of settings (e.g., SCS, scheduling type, BLER target, etc.).

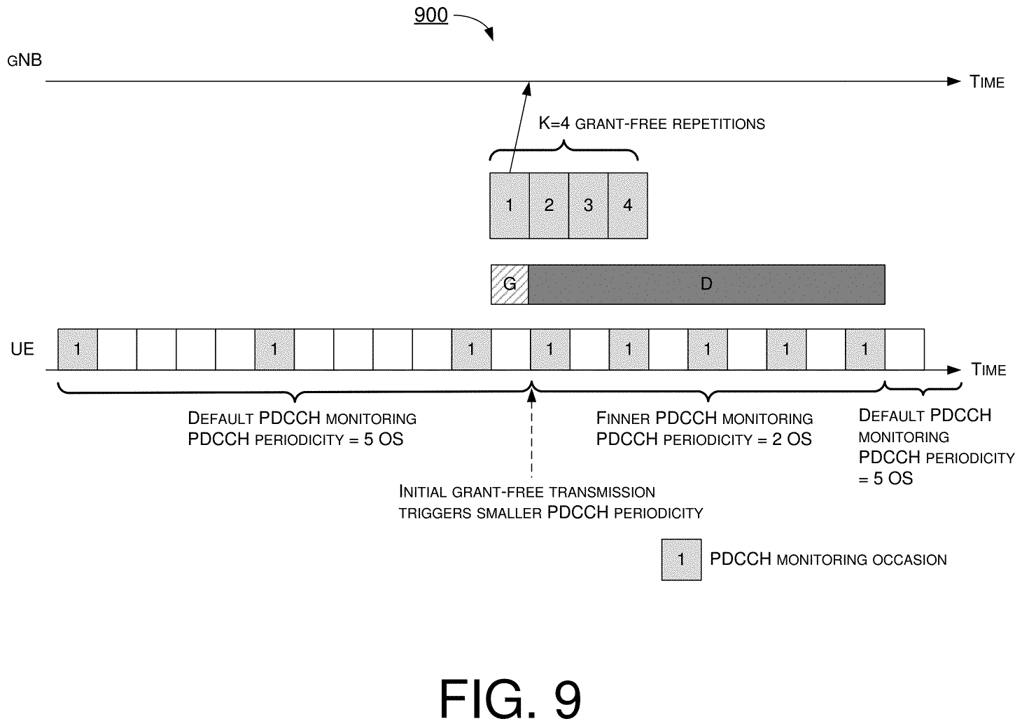

FIG. 9 illustrates an example scenario 900 under schemes in accordance with implementations of the present disclosure. Scenario 900 involves a UE and a network node, which may be a part of a wireless communication network (e.g., an LTE network, an LTE-Advanced network, an LTE-Advanced Pro network, a 5G network, an NR network, an loT network or an NB-IoT network). The secondary configuration may be used for the grant-free transmission. The secondary configuration may be triggered when transmitting via UL grant-free resources. The UE may be configured with grant-free repetitions (e.g., K=4). After transmitting the initial grant-free transmission, the UE may be triggered to initiate the secondary configuration to monitor the PDCCH. The start of the secondary configuration may be triggered after a guard period from transmitting the initial grant-free transmission.

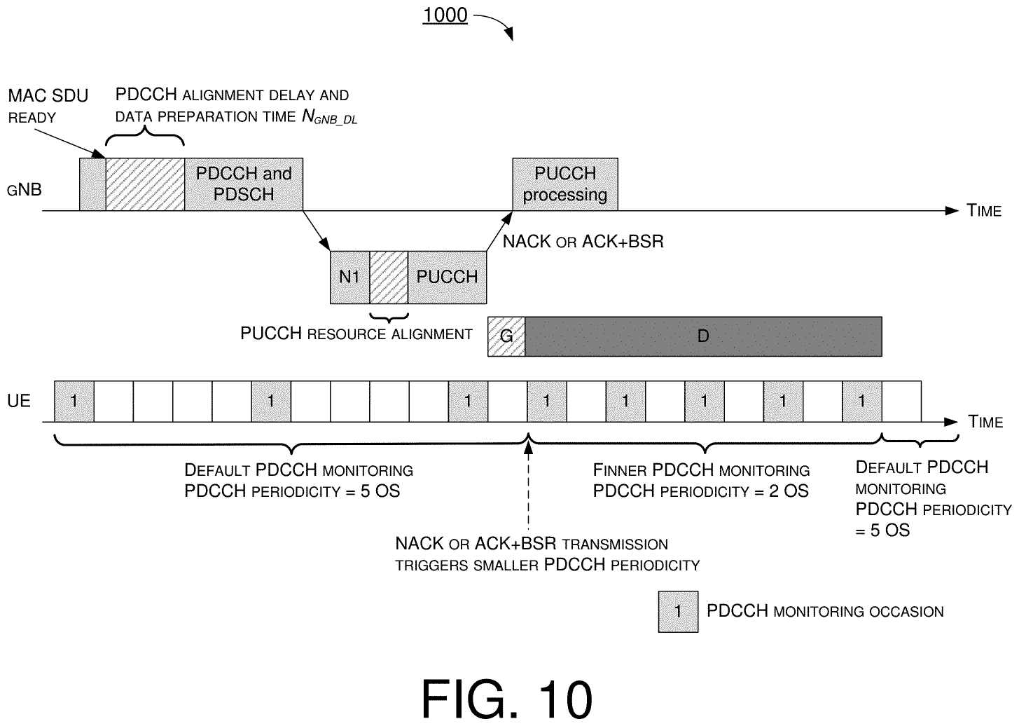

FIG. 10 illustrates an example scenario 1000 under schemes in accordance with implementations of the present disclosure. Scenario 1000 involves a UE and a network node, which may be a part of a wireless communication network (e.g., an LTE network, an LTE-Advanced network, an LTE-Advanced Pro network, a 5G network, an NR network, an loT network or an NB-IoT network). The secondary configuration may be used to improve the DL latency. The secondary configuration may be triggered by NACK or when more UL data is expected. Specifically, after receiving the PDSCH, the UE may need to transmit the ACK or NACK based on the decoding result of the PDSCH. In an event that the UE transmits the NACK, the UE may expect further retransmissions from the network node. Thus, the UE may be triggered to initiate the secondary configuration to monitor the PDCCH for possible DL transmission. In an event that the UE transmits the ACK and BSR, the UE may have more data needed to be transmitted to the network node. Thus, the UE may be triggered to initiate the secondary configuration to monitor the PDCCH for possible UL transmission.

In the above-mentioned scenarios, the number of blind decoding at the UE side may be increased by using the secondary configuration due to the shorter PDCCH periodicity (e.g., the denser Monitoring-symbols-PDCCH-within-slot bitmap). The UE blind decoding may be controlled by higher layer RRC parameters. The number of blind decoding allowed within the slot may be adjusted depending on the number of DCI formats that the UE should monitor, the allowed aggregation levels, the number of PDCCH candidates per aggregation level. The network node may select the proper configuration to restrict the UE blind decoding within a reasonable range. The primary and secondary PDCCH monitoring configurations should be taken into account to restrict the UE blind decoding to maintain it within the reasonable range. For example, the network node and/or the UE may be configured to reduce the number of monitored aggregation levels, DCI formats and/or PDCCH candidates when the secondary configuration is used.

### Illustrative Implementations

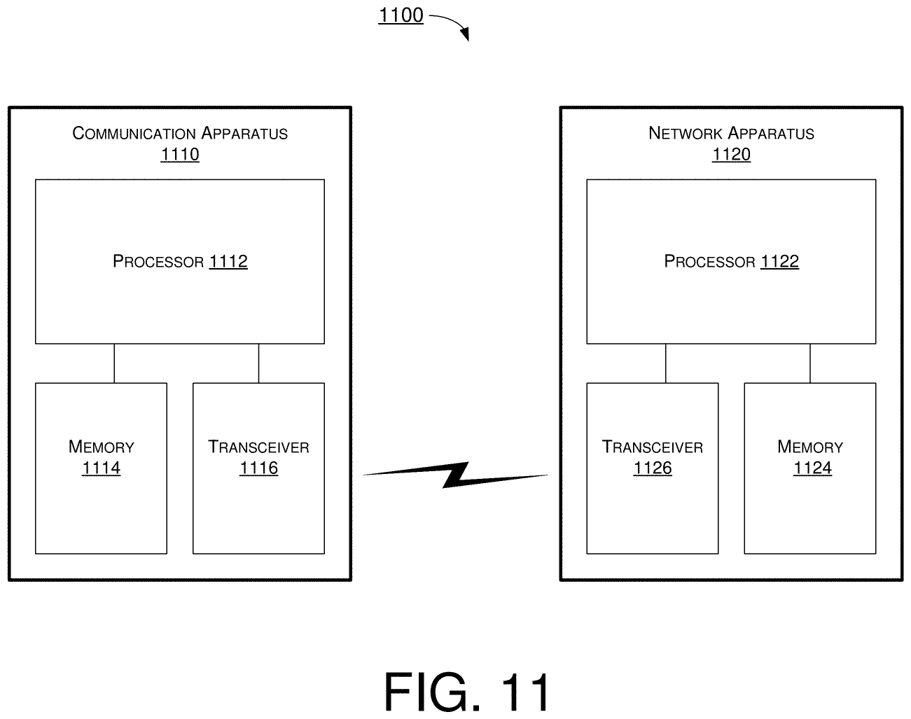

FIG. 11 illustrates an example communication apparatus 1110 and an example network apparatus 1120 in accordance with an implementation of the present disclosure. Each of communication apparatus 1110 and network apparatus 1120 may perform various functions to implement schemes, techniques, processes and methods described herein pertaining to PDCCH monitoring configuration with respect to user equipment and network apparatus in wireless communications, including scenarios/schemes described above as well as process 1200 described below.

Communication apparatus 1110 may be a part of an electronic apparatus, which may be a UE such as a portable or mobile apparatus, a wearable apparatus, a wireless communication apparatus or a computing apparatus. For instance, communication apparatus 1110 may be implemented in a smartphone, a smartwatch, a personal digital assistant, a digital camera, or a computing equipment such as a tablet computer, a laptop computer or a notebook computer. Communication apparatus 1110 may also be a part of a machine type apparatus, which may be an loT or NB-IoT apparatus such as an immobile or a stationary apparatus, a home apparatus, a wire communication apparatus or a computing apparatus. For instance, communication apparatus 1110 may be implemented in a smart thermostat, a smart fridge, a smart door lock, a wireless speaker or a home control center. Alternatively, communication apparatus 1110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1110 may include at least some of those components shown in FIG. 11 such as a processor 1112, for example. Communication apparatus 1110 may further include one or more other components not pertinent to the proposed scheme of the present disclosure (e.g., internal power supply, display device and/or user interface device), and, thus, such component(s) of communication apparatus 1110 are neither shown in FIG. 11 nor described below in the interest of simplicity and brevity.

Network apparatus 1120 may be a part of an electronic apparatus, which may be a network node such as a base station, a small cell, a router or a gateway. For instance, network apparatus 1120 may be implemented in an eNodeB in an LTE, LTE-Advanced or LTE-Advanced Pro network or in a gNB in a 5G, NR, loT or NB-IoT network. Alternatively, network apparatus 1120 may be implemented in the form of one or more IC chips such as, for example and without limitation, one or more single-core processors, one or more multi-core processors, or one or more RISC or CISC processors. Network apparatus 1120 may include at least some of those components shown in FIG. 11 such as a processor 1122, for example. Network apparatus 1120 may further include one or more other components not pertinent to the proposed scheme of the present disclosure (e.g., internal power supply, display device and/or user interface device), and, thus, such component(s) of network apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including PDCCH monitoring configuration with respect to user equipment and network apparatus in mobile communications in accordance with various implementations of the present disclosure.

In some implementations, communication apparatus 1110 may also include a transceiver 1116 coupled to processor 1112 and capable of wirelessly transmitting and receiving data. In some implementations, communication apparatus 1110 may further include a memory 1114 coupled to processor 1112 and capable of being accessed by processor 1112 and storing data therein. In some implementations, network apparatus 1120 may also include a transceiver 1126 coupled to processor 1122 and capable of wirelessly transmitting and receiving data. In some implementations, network apparatus 1120 may further include a memory 1124 coupled to processor 1122 and capable of being accessed by processor 1122 and storing data therein. Accordingly, communication apparatus 1110 and network apparatus 1120 may wirelessly communicate with each other via transceiver 1116 and transceiver 1126, respectively. To aid better understanding, the following description of the operations, functionalities and capabilities of each of communication apparatus 1110 and network apparatus 1120 is provided in the context of a mobile communication environment in which communication apparatus 1110 is implemented in or as a communication apparatus or a UE and network apparatus 1120 is implemented in or as a network node of a communication network.

In some implementations, processor 1112 may be configured to receive, via transceiver 1116, a primary configuration and a secondary configuration. The primary configuration may comprise a first PDCCH periodicity. The secondary configuration may comprise a second PDCCH periodicity which is smaller than the first PDCCH periodicity. Processor 1112 may be configured to monitor, via transceiver 1116, the PDCCH according to the primary configuration by default. Then, processor 1112 may determine whether a condition is satisfied. In an event that the condition is satisfied, processor 1112 may be configured to monitor the PDCCH according to the secondary configuration. Processor 1112 may use the primary configuration to monitor the DL traffic. Processor 1112 may use the secondary configuration to monitor the UL traffic.

In some implementations, processor 1112 may be configured with a first PDCCH monitoring configuration and a second PDCCH monitoring configuration. At first, processor 1112 may be configured to monitor the PDCCH according to the first PDCCH monitoring configuration (e.g., every 5 OS). Then, processor 1112 may be configured to transmit, via transceiver 1116, an SR message to network apparatus 1120. After transmitting the SR message, processor 1112 may expect the following DL transmission from network apparatus 1120 on the PDCCH. Therefore, the transmission of the SR message may trigger processor 1112 to perform finer PDCCH monitoring. Then, processor 1112 may be configured to monitor, via transceiver 1116, the PDCCH according to the second PDCCH monitoring configuration (e.g., every 2 OS).

In some implementations, processor 1112 may be configured with a secondary configuration that is applied at certain period of times based on specific triggers/conditions. The specific triggers/conditions may comprise transmitting at least one of an SR message, a NACK, and a BSR. For example, processor 1112 may be configured with a primary and a secondary PDCCH monitoring configurations in the same search space. In another example, processor 1112 may be configured with a search space that is monitored at certain period of times based on specific triggers/conditions.

In some implementations, the primary configuration and/or the secondary configuration may be configured by network apparatus 1120 via the RRC configuration. The parameters used for the secondary configuration may be predetermined and/or pre-stored in memory 1114. Processor 1122 may enable and/or disable the secondary configuration by the RRC configuration. Processor 1122 may also trigger the use of the secondary configuration dynamically via the DCI. Processor 1122 may signal/change the settings for the secondary configuration dynamically. The secondary configuration may be used for a temporary duration, and then processor 1112 will switch back to the default configuration. The primary configuration may be monitored by processor 1112 during the period where the secondary configuration is monitored by processor 1112. Alternatively, the primary configuration may be not monitored by processor 1112 during the period where the secondary configuration is monitored by processor 1112.

In some implementations, processor 1112 may be configured to initiate the monitoring of the PDCCH according to the secondary configuration after a guard period from transmitting at least one of the SR message, the NACK, and the BSR. During the guard period, processor 1112 may still use the primary configuration. The start of the period G may be straight after the SR transmission. The value of G may be pre-stored in memory 1114 or RRC configured by network apparatus 1120.

In some implementations, the secondary configuration may be enabled during a temporary duration. Processor 1112 may be configured to monitor the PDCCH according to the secondary configuration in the temporary duration. The start and the length of the temporary duration may be known to both communication apparatus 1110 and network apparatus 1120. At least one of the start and the length of the temporary duration may comprise a predetermined value or a configured value received from network apparatus 1120.

In some implementations, the length of the temporary duration may be a fixed duration which is RRC configured by network apparatus 1120 or pre-stored in memory 1114. When the the temporary duration is finished, processor 1112 may be configured to stop monitoring the PDCCH according to the secondary configuration and switch back to the default PDCCH monitoring configuration (e.g., the primary configuration).

In some implementations, processor 1112 may extend the temporary duration to the next PUSCH in an event that there is data to be transmitted (e.g., the packet to be retransmitted). In some implementations, processor 1112 may initiate a timer that is started after the PUSCH is transmitted. When the timer expires, processor 1112 may be configured to stop monitoring the PDCCH according to the secondary configuration and switch back to the default PDCCH monitoring configuration (e.g., the primary configuration).

In some implementations, the temporary duration may take into account the BSR information if available at network apparatus 1120. The use of the secondary configuration may be extended when communication apparatus 1110 has more data in its buffer. Processor 1122 may recognize that the secondary configuration was extended based on the BSR information. In an event that the BSR information is not available, processor 1112 may, by its own initiative, extend the use of the secondary configuration in an event that it still has more data to be transmitted, and switch back to the primary configuration once all the UL data are sent out. Processor 1122 may recognize that by making the assumption that communication apparatus 1110 may have more UL data to be sent out. Once the allocated resources are not used by communication apparatus 1110, processor 1122 may recognize communication apparatus 1110 has sent out all of its data and switched to the primary configuration.

In some implementations, in order to reduce the monitoring effort, processor 1122 may switch back temporarily to the primary configuration during the processing time (e.g., N2) and the PUSCH transmission time.

In some implementations, processor 1112 and/or 1122 may use the secondary configuration for the grant-free transmission. Processor 1112 may be configured with grant-free repetitions. After transmitting the initial grant-free transmission, processor 1112 may be triggered to initiate the secondary configuration to monitor the PDCCH. The start of the secondary configuration may be triggered after a guard period from transmitting the initial grant-free transmission.

In some implementations, processor 1112 and/or 1122 may use the secondary configuration to improve the DL latency. The secondary configuration may be triggered by NACK or when more UL data is expected. Specifically, after receiving the PDSCH, processor 1112 may need to transmit, via transceiver 1116, the ACK or NACK based on the decoding result of the PDSCH. In an event that processor 1112 transmits the NACK, processor 1112 may expect further retransmissions from network apparatus 1120. Thus, processor 1112 may be triggered to initiate the secondary configuration to monitor the PDCCH for possible DL transmission. In an event that processor 1112 transmits the ACK and BSR, processor 1112 may have more data needed to be transmitted to network apparatus 1120. Thus, processor 1112 may be triggered to initiate the secondary configuration to monitor the PDCCH for possible UL transmission.

In some implementations, processor 1122 may select the proper configuration to restrict the blind decoding within a reasonable range. The primary and secondary PDCCH monitoring configurations should be taken into account to restrict the blind decoding to maintain it within the reasonable range. Processor 1112 and/or 1122 may be configured to reduce the number of monitored aggregation levels, DCI formats and/or PDCCH candidates when the secondary configuration is used.

### Illustrative Processes

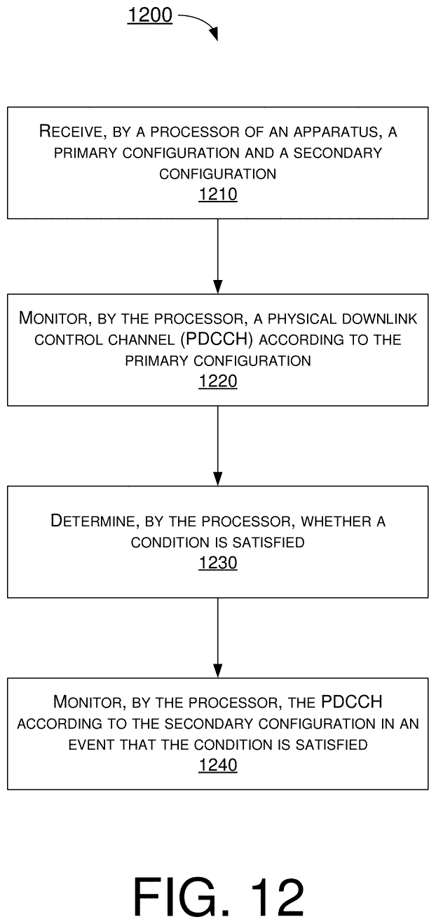

FIG. 8 illustrates an example process 1200 in accordance with an implementation of the present disclosure. Process 1200 may be an example implementation of above scenarios/schemes, whether partially or completely, with respect to PDCCH monitoring configuration with the present disclosure. Process 1200 may represent an aspect of implementation of features of communication apparatus 1110. Process 1200 may include one or more operations, actions, or functions as illustrated by one or more of blocks 1210, 1220, 1230 and 1240. Although illustrated as discrete blocks, various blocks of process 1200 may be divided into additional blocks, combined into fewer blocks, or eliminated, depending on the desired implementation. Moreover, the blocks of process 1200 may executed in the order shown in FIG. 12 or, alternatively, in a different order. Process 1200 may be implemented by communication apparatus 1110 or any suitable UE or machine type devices. Solely for illustrative purposes and without limitation, process 1200 is described below in the context of communication apparatus 1110. Process 1200 may begin at block 1210.

At 1210, process 1200 may involve processor 1112 of apparatus 1110 receiving a primary configuration and a secondary configuration. Process 1200 may proceed from 1210 to 1220.

At 1220, process 1200 may involve processor 1112 monitoring a PDCCH according to the primary configuration. Process 1200 may proceed from 1220 to 1230.

At 1230, process 1200 may involve processor 1112 determining whether a condition is satisfied. Process 1200 may proceed from 1230 to 1240.

At 1240, process 1200 may involve processor 1112 monitoring the PDCCH according to the secondary configuration in an event that the condition is satisfied. The primary configuration may comprise a first PDCCH periodicity. The secondary configuration may comprise a second PDCCH periodicity which is smaller than the first PDCCH periodicity.

In some implementations, the condition may comprise transmitting at least one of an SR message, a NACK, and a BSR.

In some implementations, process 1200 may involve processor 1112 initiating the monitoring of the PDCCH according to the secondary configuration after a guard period from transmitting at least one of the SR message, the NACK, and the BSR.

In some implementations, the secondary configuration may comprise at least one of a secondary PDCCH monitoring configuration and a search space to be monitored at a period of time.

In some implementations, the primary configuration may be configured to monitor downlink traffic. The secondary configuration may be configured to monitor uplink traffic.

In some implementations, process 1200 may involve processor 1112 monitoring the PDCCH according to the secondary configuration in a temporary duration.

In some implementations, at least one of a start and a length of the temporary duration may comprise a predetermined value or a configured value received from the network node.

In some implementations, process 1200 may involve processor 1112 stopping the monitoring of the PDCCH according to the secondary configuration when the temporary duration is finished.

In some implementations, process 1200 may involve processor 1112 extending the temporary duration in an event that there is data to be transmitted.

In some implementations, process 1200 may involve processor 1112 initiating a timer. Process 1200 may further involve processor 1112 stopping the monitoring of the PDCCH according to the secondary configuration when the timer is expired.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a primary configuration and a secondary configuration;
monitoring, by the processor, a physical downlink control channel (PDCCH) according to the primary configuration;
determining, by the processor, whether a condition is satisfied; and
monitoring, by the processor, the PDCCH according to the secondary configuration in an event that the condition is satisfied,
wherein the primary configuration comprises a first PDCCH periodicity, and
wherein the secondary configuration comprises a second PDCCH periodicity which is smaller than the first PDCCH periodicity.

2. The method of claim 1, wherein the condition comprises transmitting at least one of a service request (SR) message, a negative acknowledgement (NACK), and a buffer status report (BSR).

3. The method of claim 2, further comprising:
initiating, by the processor, the monitoring of the PDCCH according to the secondary configuration after a guard period from transmitting at least one of the SR message, the NACK, and the BSR.

4. The method of claim 1, wherein the secondary configuration comprises at least one of a secondary PDCCH monitoring configuration and a search space to be monitored at a period of time.

5. The method of claim 1, wherein the primary configuration is configured to monitor downlink traffic, and wherein the secondary configuration is configured to monitor uplink traffic.

6. The method of claim 1, wherein the monitoring of the PDCCH according to the secondary configuration comprises monitoring the PDCCH according to the secondary configuration in a temporary duration.

7. The method of claim 6, wherein at least one of a start and a length of the temporary duration comprises a predetermined value or a configured value received from a network node.

8. The method of claim 6, further comprising:
stopping, by the processor, the monitoring of the PDCCH according to the secondary configuration when the temporary duration is finished.

9. The method of claim 6, further comprising:
extending, by the processor, the temporary duration in an event that there is data to be transmitted.

10. The method of claim 1, further comprising:
initiating, by the processor, a timer; and
stopping, by the processor, the monitoring of the PDCCH according to the secondary configuration when the timer is expired.

11. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a primary configuration and a secondary configuration from the network node;
monitoring, via the transceiver, a physical downlink control channel (PDCCH) according to the primary configuration;
determining whether a condition is satisfied; and
monitoring, via the transceiver, the PDCCH according to the secondary configuration in an event that the condition is satisfied,
wherein the primary configuration comprises a first PDCCH periodicity, and wherein the secondary configuration comprises a second PDCCH periodicity which is smaller than the first PDCCH periodicity.

12. The apparatus of claim 11, wherein the condition comprises transmitting at least one of a service request (SR) message, a negative acknowledgement (NACK), and a buffer status report (BSR).

13. The apparatus of claim 12, wherein, during operation, the processor further performs operations comprising:
initiating the monitoring of the PDCCH according to the secondary configuration after a guard period from transmitting at least one of the SR message, the NACK, and the BSR.

14. The apparatus of claim 11, wherein the secondary configuration comprises at least one of a secondary PDCCH monitoring configuration and a search space to be monitored at a period of time.

15. The apparatus of claim 11, wherein the primary configuration is configured to monitor downlink traffic, and wherein the secondary configuration is configured to monitor uplink traffic.

16. The apparatus of claim 11, wherein, in monitoring the PDCCH according to the secondary configuration, the processor monitors the PDCCH according to the secondary configuration in a temporary duration.

17. The apparatus of claim 16, wherein at least one of a start and a length of the temporary duration comprises a predetermined value or a configured value received from the network node.

18. The apparatus of claim 16, wherein, during operation, the processor further performs operations comprising:
stopping the monitoring of the PDCCH according to the secondary configuration when the temporary duration is finished.

19. The apparatus of claim 16, wherein, during operation, the processor further performs operations comprising:
extending the temporary duration in an event that there is data to be transmitted.

20. The apparatus of claim 11, wherein, during operation, the processor further performs operations comprising:
initiating a timer; and
stopping the monitoring of the PDCCH according to the secondary configuration when the timer is expired.
